(19) United States
(12) Patent Application Publication
(10) Pub. No.: US 2020/0047497 A1
(43) Pub. Date: Feb. 13, 2020

(54) HOUSING WITH CURVED SURFACE

(71) Applicant: HEWLETT-PACKARD DEVELOPMENT COMPANY, L.P., Spring, TX (US)

(72) Inventors: Alejandro MIELGO, Sant Cugat del Valles (ES); Jose Francisco BRAVO, Sant Cugat del Valles (ES); Jordi BAS, Sant Cugat del Valles (ES)

(21) Appl. No.: 16/340,651

(22) PCT Filed: Jan. 25, 2017
(86) PCT No.: PCT/US2017/014946

§ 371 Date: Apr. 9, 2019

(51) Int. Cl. B41J 2/125; B41J 2/165; B41J 2/21

(52) U.S. Cl. CPC B41J 2/125; G01N 2021/8564; B41J 2/2142; B41J 2/16579

(57) ABSTRACT

Examples disclosed herein relate to a housing with a curved surface. In examples, the housing may receive a light source and a detector to detect a droplet passing through a light path between the detector and the light source. The housing may have a curved surface to align the detector and the light source within the housing.

### BACKGROUND

A detector may be used to detect the occurrence of an event. For example, a detector may be used to determine whether a fluidic drop or particle passes near or proximate the detector. In such an example, drop detectors may be used to determine whether a droplet (either a fluid or a solid) is ejected from a print element and deposited onto a substrate.

### BRIEF DESCRIPTION OF THE DRAWINGS

The following detailed description references the drawings, wherein:

FIG. 1 is a schematic perspective view of a system according to an example.

FIG. 2 is a schematic perspective view of the system of FIG. 1 according to an example.

FIG. 3 is a schematic perspective view of a sub-housing of FIG. 1 according to an example.

FIG. 4 is a schematic perspective view of a sub-housing of FIG. 1 according to an example.

FIG. 5 is a schematic perspective view of a system according to an example.

FIG. 6 is a sectional view of the system of FIG. 5 taken along line 6-6′ according to an example.

FIG. 7 is a sectional view of the system of FIG. 5 taken along line 7-7′ according to an example.

### DETAILED DESCRIPTION

Drop detectors may be used to detect whether droplets (e.g., fluids or solids) ejected from an element. For example, drop detectors may detect whether droplets are ejected from a print element, such as a nozzle of a printhead, towards a substrate. In examples, an array of drop detectors may be able to assist in diagnosing nozzle health in a print element such as an inkjet printhead. The drop detector may include a light source and a photo-detector. In examples, the drop detector may operate to detect when a droplet intersects a path of light emitted from the light source. In such examples, if no drop is detected, the light is not intersected and detected by the photo-detector. If a drop is detected, the photo detector detects a break in the light that reaches the photo-detector as the droplet intersects the light. In order to detect small perturbations in a light path, the photo-detector of the drop detector should be aligned with the light source within a small tolerance. However, it is challenging to provide a well aligned plurality of drop detectors due to poor manufacturing tolerances and high costs.

To address these issues, in the examples described herein, a drop detector includes a curved surface to align a detector and/or a light source within a housing. In examples, the curved surface has a changing radius along a center line. In examples, the curved surface may be coupled to a portion of an outer surface of the detector and/or light source. In this manner, examples described herein may significantly reduce drop detector misalignment and manufacturing costs.

In the following discussion and in the claims, the term “couple” or “couples” is intended to include suitable indirect and/or direct connections. Thus, if a first component is described as being coupled to a second component, that coupling may, for example, be: (1) through a direct electrical or mechanical connection, (2) through an indirect electrical or mechanical connection via other devices and connections, (3) through an optical electrical connection, (4) through a wireless electrical connection, and/or (5) another suitable coupling. The term “droplet” as used herein refers to either a small portion of a liquid or a particle of a solid.

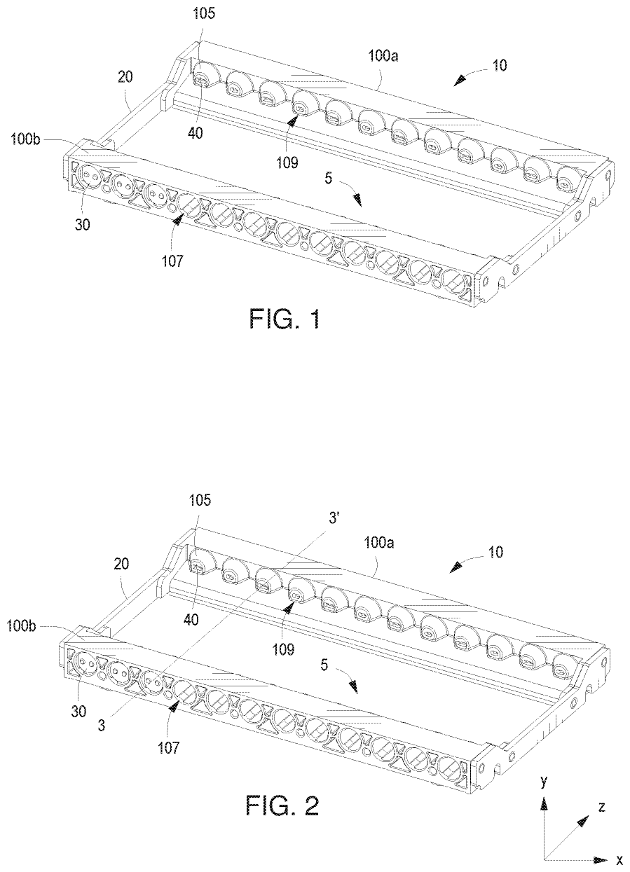

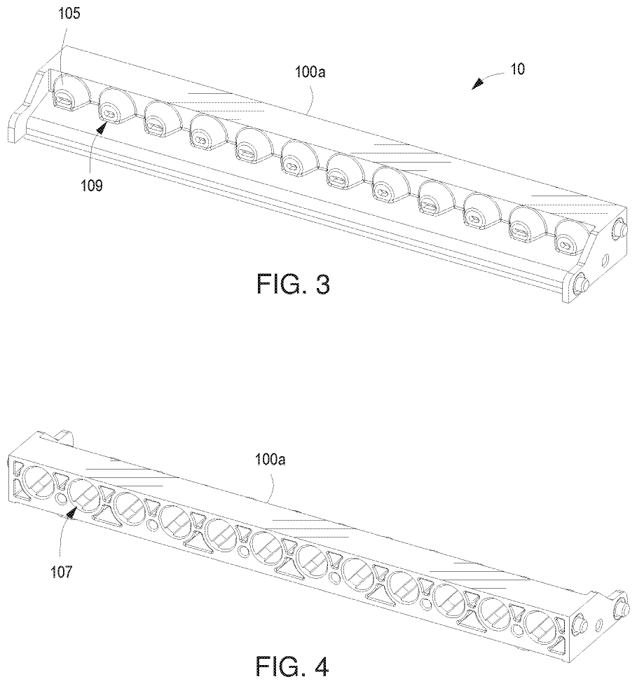

Referring now to the drawings, FIG. 1 is a schematic perspective view of a system 10 according to an example. FIG. 2 is a schematic perspective view of system 10 of FIG. 1 according to an example. FIG. 3 is a schematic perspective view of a sub-housing 100a of FIG. 1 according to an example. FIG. 4 is a schematic perspective view of sub-housing 100a of FIG. 1 according to an example. System 10 includes a housing 20 including a curved surface 105. In examples, housing 20 may receive a light source 30 and a detector 40 to detect a drop passing through a light path between detector 40 and the light source 30. In the examples, curved surface 105 may align detector 40 and light source 30 within housing 20. In some examples, the housing 20 may include one or more deformable surface to guide detector 40 and light source 30 toward curved surface 105 to align detector 40 and light source 30 within housing 20. In the examples, housing 20 includes a first sub-housing 100a and a second sub-housing 100b. In examples, sub-housing 100a and sub-housing 100b may be disposed substantially parallel to each other to form a space 5 therebetween. In examples, sub-housing 100a may receive a plurality of light sources 30 and sub-housing 100b may receive a plurality of detectors 40. In the examples, sub-housing 100a and sub-housing 100b may be substantially similar. In other examples, sub-housing 100a and sub-housing 100b may differ.

In examples, light source 30 may be any light source to provide a path of light between two areas and any optical elements necessary to focus the emitted light, such as a light-emitting diode (LED), laser, florescent bulb, etc. In examples, detector 40 may be any detector to detect light such as a photodiode. In examples, detector 40 may detect a shadow formed by a droplet passing through a light path between detector 40 and light source 30. In such examples, the droplet may be a fluid drop of an ink. In examples, a particle may be a particle of any solid to be detected in the light path, such as, a ceramic, a composite, a metal, etc.

In examples, sub-housing 100a and sub-housing 100b may receive one or more of light sources 30, detectors 40, or a combination thereof. In examples, one or both of sub-housing 100a and sub-housing 100b may include opening 107 to receive either light source 30 or detector 40. In examples, one or both of sub-housing 100a and sub-housing 100b may include opening 109 disposed opposite opening 107. In examples, opening 107 may be larger than opening 109. In examples, opening 109 may be disposed to be exposed to a light path formed between light source 30 and detector 40. In such examples, opening 109 may be formed of at least a portion of curved surface 105. In examples, sub-housing 100a and sub-housing 100b may align a pair of light source 30 and detector 40 coupled thereto to form a light path therebetween. In some examples, sub-housing 100a and/or sub-housing 100b may include one or more deformable surfaces to guide detector 40 and light source 30 toward curved surface 105. In such examples, a portion of detector 40 and light source 30 may be coupled to curved surface 105 and the one or more deformable surfaces.

In examples, one or both of sub-housing 100a and sub-housing 100b may include curved surface 105 to guide light source 30 and detector 40 into alignment. In examples, curved surface 105 may have a decreasing radius along a center line 3-3′ extending along a z-axis. In such examples, curved surface 105 may have an annulus cross-section. In other examples, curved surface 105 may have any polygon as a cross-sectional shape. In examples, curved surface 105 may be any shape formed when a curved surface is intersected by a plane. In examples, curved surface 105 may be complementary to at least a portion of an external surface of light source 30 or the detector 40 so that a portion of light source 30 or the detector 40 is coupled to the curved surface 105. In such examples, in operation, curved surface 105 may connect to light source 30 or detector 40 at one or more points.

In examples, sub-housing 100a and sub-housing 100b may be composed of one or more of a plastic, a metal (e.g., aluminum, copper, etc.), a ceramic, a composite, etc. For examples, sub-housing 100a and sub-housing 100b may be composed of an injected molded plastic. In examples, sub-housing 100a and sub-housing 100b may be composed of one or more of acrylonitrile butadiene styrene (ABS), Polypropylene (PP), polycarbonate (PC), Polycarbonate/Acrylonitrile Butadiene Styrene (PCABS), nylons, polyphenylene ether (PPO), etc.

In examples, in operation, sub-housing 100a and/or sub-housing 100b may include a curved surface 105 to guide a light source 30 or detector 40 disposed in opening 107 towards opening 109. In such examples, curved surface 105 may be used to align light source 30 and detector 40. In examples, housing 20 includes a plurality of light source 30 and detector 40 pairs. In examples, housing 20 may be coupled to electronic circuitry to control light source 30 and detector 40.

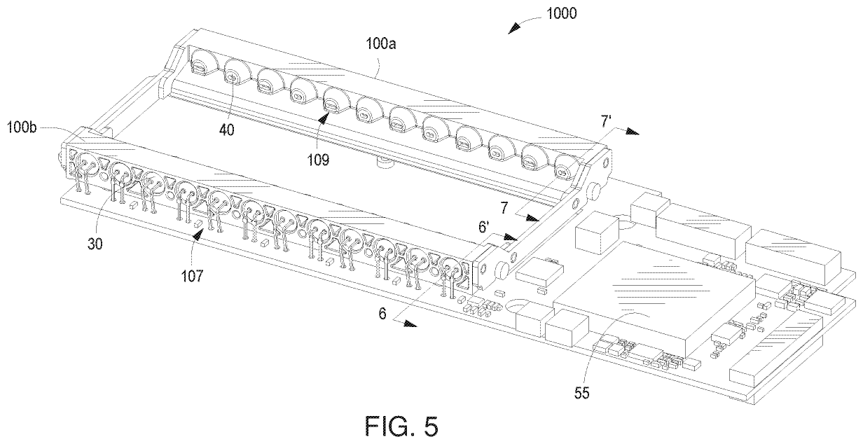

FIG. 5 is a schematic perspective view of a system 1000 according to an example. In examples, system 1000 includes system 10 coupled to electronic circuitry 55. In such examples, electronic circuity 55 may include one or more components to activate and/or control detector 40 and light source 30. In examples, electronic circuitry 55 may also include components to power the light source 30 and detectors 40. In such examples, system 1000 may be a drop detector to detect a perturbation in a light path. In examples, system 1000 may be coupled to a print element or printhead to determine nozzle health.

In the example of FIG. 5, a plurality of light sources 30 may be coupled to sub-housing 100b and a plurality of detectors 40 may be coupled to sub-housing 100a to form an array of drop detectors. In such an examples, each light source 30 and detector 40 pair may determine if a droplet interferes with a light path formed therebetween. In examples, drop detector 1000 may be coupled to an imaging device to determine whether a printing element or other element ejects a droplet towards a substrate. In examples, the substrate may be a media or a test bed to receive a fluid or solid. A “printing device” may be a hardware device, such as a printer (e.g., 2-D printer or 3-D printer), scanner, copier, multifunction printer (MFP), or any other device with functionalities to physically produce representation(s) (e.g., text, images, models, etc.) on a substrate. In some examples, an MFP may be capable of performing a combination of multiple different functionalities such as, for example, printing, photocopying, scanning, faxing, etc. A substrate may be any type of test bed, paper, photopolymers, thermopolymers, plastics, fabric, composite, metal, wood, etc.

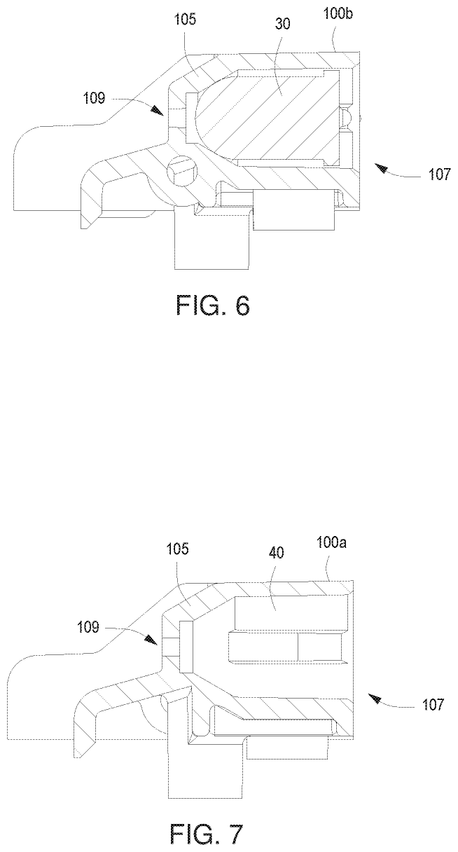

FIG. 6 is a sectional view of the system of FIG. 5 taken along line 6-6′ according to an example. In the example of FIG. 6, a cross-sectional view depicts light source 30 disposed inside housing 100b. In such examples, curved surface 105 may be disposed adjacent to or may abut a portion of light source 30. In such an example, light source 30 may emit light from opening 109 toward detector 40 disposed parallel and spaced apart from light source 30. FIG. 7 is a sectional view of the system of FIG. 5 taken along line 7-7′ according to an example. In the example of FIG. 7, a cross-sectional view depicts detector 40 disposed inside housing 100a. In such examples, curved surface 105 may be disposed adjacent to or may abut a portion of detector 40. In such an example, detector 40 may receive light from opening 109. In operation, when light source 30 is inserted into opening 107 of sub-housing 100b, light source 30 may be guided towards opening 109. Similarly, in operation, when detector 40 is inserted into opening 107 of sub-housing 100a, detector 40 may be guided towards opening 109. In such a manner, curved surfaces 105 of housing 20 guide a light source and detector pair into alignment in a drop detector 1000.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. Furthermore, it should be understood that the systems, apparatuses, and methods described herein can include various combinations and/or sub-combinations of the components and/or features of the different implementations described. Thus, features described with reference to one or more implementations can be combined with other implementations described herein.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

1. A system, comprising:
a housing to receive a light source and a detector to detect a droplet passing through a light path between the detector and the light source; and
a curved surface of the housing to align the detector and the light source within the housing.

2. The system of claim 1, wherein the curved surface has a varying radius along a center line.

3. The system of claim 1, wherein the curved surface is complementary to an external surface of the light source or the detector so that a portion of the light source or the detector is coupled to the curved surface.

4. The system of claim 1, wherein the housing is an injection molded plastic.

5. The system of claim 1, wherein the light source is a light emitting diode (LED).

6. The system of claim 1, comprising an ejector to eject the droplet.

7. A device, comprising:
an ejector to eject a droplet towards a substrate;
a light source;
a photo-detector to detect a shadow formed by the droplet passing through a light path between the detector and the light source; and
a curved surface to guide the light source and the photo-detector into alignment.

8. The device of claim 7, wherein the curved surface has a varying radius along a center line.

9. The device of claim 7, wherein the curved surface is to be complementary to an external surface of the light source or the photo-detector so that a portion of the light source or the photo-detector is coupled to the curved surface.

10. The device of claim 7, wherein the curved surface is in contact with the light source or the photo-detector.

11. The device of claim 7, wherein the light source is a light emitting diode (LED).

12. The device of claim 7, wherein the ejector is a printhead.

13. An imaging device, comprising:
a printhead to eject a droplet towards a substrate;
a light source;
a photo-detector to detect the droplet passing through a light path between the detector and the light source; and
a curved surface to align the light source and the photo-detector into alignment,
wherein the curved surface has an annulus cross-section.

14. The imaging device of claim 13, wherein the curved surface has a varying radius along a center line.

15. The imaging device of claim 13, wherein the curved surface is configured to be complementary to an external surface of the light source or the photo-detector so that a portion of the light source or the photo-detector is in contact with the curved surface.
